(19) United States
(12) Patent Application Publication
(10) Pub. No.: US 2005/0137294 A1
(43) Pub. Date: Jun. 23, 2005

(54) Water-soluble alkyd resin composition and paint produced using the same

(75) Inventor: Peter Sibbett, Tacoma, WA (US)

Correspondence Address: BACON & THOMAS, PLLC, 625 SLATERS LANE, FOURTH FLOOR, ALEXANDRIA, VA, 22314, US

(73) Assignee: CAPSTONE ENGINEERING LTD., Gyeongnam (KR)

(21) Appl. No.: 10/865,866

(22) Filed: Jun. 14, 2004

(30) Foreign Application Priority Data
Dec. 23, 2003 (KR) 10-2003-00952228

(51) Int. Cl. C08L 67/00

(52) U.S. Cl. 523/500

(57) ABSTRACT

Disclosed herein is a water-soluble alkyd composition, which comprises an ester reactant consisting of a dehydrated fatty acid (DCOFA), trimethylolpropane (TMP), isophthalic acid (IP acid), trimellitic anhydride (TMA) and butyl cellosolve; a mixture of acrylic monomers including methyl methacrylate (MMA), n-butyl methacrylate (n-BMA), butyl acrylate monomer (BAM), styrene monomer (SM) and acrylic acid (AA); and 3˜4% by weight of triethylamine (TEA) as a pH-adjusting agent. The weight ratio of the mixture of acrylic monomers to the ester reactant is in the range of 1:0.8˜1:1. Paint produced using the alky resin composition is also disclosed. The paint exhibits improved workability and adhesiveness, particularly, excellent paintability when being applied on SMC (sheet molding compound) materials.

### BACKGROUND OF THE INVENTION

1. Field of the Invention

The present invention relates to a water-soluble alkyd resin composition and a paint produced using the alkyd resin composition, and more particularly, to an alkyd resin composition which can impart improved workability and adhesiveness, particularly, excellent paintability to a paint when applied to an SMC (sheet molding compound) material.

2. Description of the Related Art

Alkyd resins are polymeric products prepared by condensation reaction of polyhydric alcohols and polybasic acids. Since alkyd resins contain trihydric or higher alcohols and drying oils, they are linear polymers before being painted, but are transformed into three-dimensional polymers having bridging bonds by an enameling operation or action of air after being painted. The three-dimensional polymers ensure enhanced water resistance and chemical resistance of paint. Accordingly, alkyd resins can be used as paints without any processing, or are mixed with other resins such as urea and melamine resin to use as flexible paints for bent metal structures, e.g., buildings, ships and iron bridges.

When an alkyd resin is modified with a fatty acid, the content (wt %) of a fatty acid triglyceride to be formed is called an “oil length”. A short oil length alkyd resin has an oil length of less than 45%, a medium oil length alkyd resin has an oil length of 45˜55%, a long oil length alkyd resin has an oil length of 55˜65%, and a ultra-long oil length alkyd resin has an oil length exceeding 65%.

A common paint product consists of a long oil length alkyd resin and a pigment, and is used to paint a rough material such as timber or veneer and to clearly reveal the grain. However, conventional paint products have the problem in that they should be fully dried after being painted due to their poor adhesion to a substrate.

On the other hand, since SMC materials in the form of thin plates do not involve an intermediate step (premixing) requiring vigorous mixing when molding of FRP, they can reduce damage to glass fibers, which is a drawback of BMC materials. Like in spray-up, glass fibers cut at a uniform length are distributed in a resin mixture supplied from upper and lower portions of a carrier film. The resin mixture including short fibers is heated during passing through pressure rollers to cure it and is then formed into a thin plate. Since the resin product thus produced has excellent productivity, it is used in a wide variety of applications.

However, conventional alkyd resin-based paint products have problems that when they are painted on SMC materials, the adhesion to the materials is poor and the workability is bad. Accordingly, conventional alkyd resin-based paint products have limited applicability to SMC materials.

### SUMMARY OF THE INVENTION

Accordingly, an object of the present invention is to provide a novel paint composition which can overcome the problems in the related art alkyd resin-based paint products and provide sufficient adhesiveness and color stability.

Further, another object of the present invention is to provide a paint composition for SMC materials which has superior workability and unchanged adhesion, regardless of changes in ambient conditions including temperature.

According to an aspect of the present invention for achieving the above objects, there is provided a water-soluble alkyd composition, comprising:
an ester reactant consisting of a dehydrated fatty acid (DCOFA), trimethylolpropane (TMP), isophthalic acid (IP acid), trimellitic anhydride (TMA) and butyl cellosolve;
a mixture of acrylic monomers including methyl methacrylate (MMA), n-butyl methacrylate (n-BMA), butyl acrylate monomer (BAM), styrene monomer (SM) and acrylic acid (AA); and
3˜4% by weight of triethylamine (TEA) as a pH-adjusting agent,
wherein the weight ratio of the mixture of acrylic monomers to the ester reactant is in the range of 1:0.8˜1:1.

The water-soluble alkyd resin composition of the present invention may be mixed with a non-toxic pigment for color expression to be used as paint. In addition, the alkyd resin composition of the present invention exhibits not only superior workability, but also excellent paintability without any deterioration in adhesiveness, regardless of changes in ambient conditions even after being painted.

### DETAILED DESCRIPTION OF THE INVENTION

The water-soluble alkyd resin composition of the present invention will be explained below, based on the respective components.

The ester reactant consists of 20˜30% by weight of a dehydrated fatty acid (DCOFA), 15˜25% by weight of trimethylolpropane (TMP), 15˜20% by weight of isophthalic acid (IP acid), 3˜7% by weight of trimellitic anhydride (TMA) and 30˜35% by weight of butyl cellosolve.

A mixture of acrylic monomers as an additive is added to the ester reactant. Examples of suitable acrylic monomers are methyl methacrylate (MMA), n-butyl methacrylate (n-BMA), butyl acrylate monomer (BAM), styrene monomer (SM), acrylic acid (AA) and the like.

A water-soluble alkyd resin is prepared in accordance with the following procedure.

First, after 20˜30% by weight of a dehydrated fatty acid (DCOFA), 15˜25% by weight of trimethylolpropane (TMP) and 15˜20% by weight of isophthalic acid (IP acid) are mixed, the mixture is allowed to stand at 160˜240° C. for 3˜7 hours.

Thereafter, 3˜7% by weight of trimellitic anhydride (TMA) is added, and then the resulting mixture is allowed to stand at about 170° C. 30˜35% by weight of butyl cellosolve is added thereto to prepare an ester reactant.

A mixture of methyl methacrylate (MMA), n-butyl methacrylate (n-BMA), butyl acrylate monomer (BAM), styrene monomer (SM) and acrylic acid (AA) is added to the ester reactant. At this time, the weight ratio of the mixture of acrylic monomers to the ester reactant is adjusted to the range of about 1:0.8˜1:1.

It is preferred that the acrylic monomers are slowly added to the ester reactant one by one rather than at one time. The mixing is continued over about 3 hours, and then the resulting mixture is maintained at about 160° C. for 4 hours. At this step, a small amount of DTBPO as an initiator can be added to the mixture.

After completion of the mixing of the ester reactant and the mixture of acrylic monomers, 3˜4% by weight of triethylamine (TEA) is added to the mixture to control pH value to 7.0, thereby imparting water-solubility to the final mixture. Finally, an appropriate amount of butyl cellosolve as a solvent is added to the final mixture to produce a water-soluble alkyd resin.

To impart the water-soluble alkyd resin a color, a pigment for color expression is blended with the alkyd resin to prepare a paste.

The blending ratio between the resin and the pigment is preferably 50˜65:35˜50 (w/w). The pigment is non-toxic and is selected depending on the desired colors. After blending, the blend is mixed at an initial speed of 1,000 rpm for 30 minutes, and is then dispersed using a disperser so as to have a particle size (fineness) of 7 μm, thereby preparing a paste of the water-soluble alkyd resin.

A separate paste having a particular color may be mixed with the paste of the water-soluble alkyd resin to produce a paint having a desired color.

The ester reactant and the solvent contained in the water-soluble alkyd resin composition of the present invention improve the workability of the paint, and the acrylic monomer components plays a roll in enhancing the adhesiveness of the paint.

Specifically, when the paint is painted on a substrate using a sprayer or the like, the ester reactant and the solvent prevent the paint components from evaporating, and facilitate a wiping operation. The acrylic monomer components enhance the adhesion of the paint to a substrate due to their large binding strength, and prevent the paint from peeling off by changes in ambient conditions, e.g. temperature or humidity.

Unlike conventional paints, the paint produced using the composition of the present invention has good adhesion to a substrate despite insufficient drying. Further, although other paint components are added to the composition, the adhesiveness is still maintained.

The water-soluble alkyd resin composition of the present invention is painted on an SMC material in accordance with the following procedure.

First, pastes of the water-soluble alkyd resin having various colors are mixed with each other to an alky resin paste having a desired color. 10˜15% by weight of the alkyd resin paste, 30˜35% by weight of a solvent and a small amount of an additive for maintaining paintability are mixed with each other to prepare a paste. The paste is mixed with a transparent paint (a water-soluble alkyd resin containing no pigment) to produce a final paint product.

An aliphatic hydrocarbon compound or cycloparaffin-based hydrocarbon compound is used as the solvent. Propylene glycol, 2,2,4-trimethyl-1,3-pentanediolmonoisobutyrate, La, Ce, Zr, Mn, Ca, Al, Zn or the like is used as the additive.

The content of the paste added to the transparent paint is preferably in the range of 30˜50% by weight as for wiping, and is in the range of 5˜15% by weight as for spraying.

The final paint thus produced is painted on an SM material using a brush or sprayer, and is then wiped using a piece of cloth. Thereafter, the painted SM material is dried at about 60° C. for 10˜30 minutes. Finally, a transparent acrylic urethane paint acting as both a protective layer and a glossing layer is top-coated on the dried SMC material. The paint applied on the SMC material exhibits superior adhesion to the SMC material, a high hardness and excellent color expression.

To determine the physical properties of the painted SMC material, the following test was performed.

First, 25% by weight of a dehydrated fatty acid (DCOFA), 20% by weight of trimethylolpropane (TMP), 17% by weight of isophthalic acid (IP acid), 5% by weight of trimellitic anhydride (TMA), and 33% by weight of butyl cellosolve were mixed to prepare an ester reactant. 10% by weight of methyl methacrylate (MMA), 10% by weight of n-butyl methacrylate (n-BMA), 10% by weight of butyl acrylate monomer (BAM), 15% by weight of styrene monomer (SM), 4% by weight of acrylic acid (AA), 3% by weight of triethylamine (TEA) and an appropriate amount of butyl cellosolve were added to 45% by weight of the ester reactant, to produce a water-soluble alkyd resin. A pigment was mixed with the alkyd resin to prepare a paste. Appropriate amounts of a solvent and other additives were mixed with the paste, and the resulting mixture was mixed with a transparent paint to produce a final paint. The final paint was applied on a plate made of an SMC material.

The painted plate was repeatedly placed under low temperature and high temperature atmospheres at regular intervals. It was checked whether cracks would be observed on the plate surface. The low temperature was set to −20° C. and the high temperature was set to 80° C. Each of the intervals was 2 hours. The low temperature and high temperature cycle was repeated six times. After six cycles, it was checked whether cracks occurred on the plate surface. However, no cracks were observed. Accordingly, it can be understood that the paint produced using the composition of the present invention exhibits good adhesiveness even under an extreme thermal impact.

As described above, the water-soluble alkyd resin composition of the present invention exhibits excellent workability and adhesiveness as paints. In particular, the alkyd resin composition prevents the paint components from evaporating during the painting, and a wiping operation can be easily performed. In addition, the alkyd resin composition enhances the adhesion of the paint to a substrate after being painted due to their large binding strength, and prevents the paint from peeling off by changes in ambient conditions, e.g. temperature or humidity. Furthermore, contrary to the conventional paints, the paint produced using the composition of the present invention has good adhesion to a substrate despite insufficient drying. Moreover, although other paint components are added to the composition of the present invention, the adhesiveness is still maintained. Accordingly, the paint of the present invention can be advantageously applied on wood and SMC materials.

1. A water-soluble alkyd composition, comprising:
an ester reactant consisting of a dehydrated fatty acid (DCOFA), trimethylolpropane (TMP), isophthalic acid (IP acid), trimellitic anhydride (TMA) and butyl cellosolve;
a mixture of acrylic monomers including methyl methacrylate (MMA), n-butyl methacrylate (n-BMA), butyl acrylate monomer (BAM), styrene monomer (SM) and acrylic acid (AA); and
3˜4% by weight of triethylamine (TEA) as a pH-adjusting agent,
wherein the weight ratio of the mixture of acrylic monomers to the ester reactant is in the range of 1:0.8˜1:1.

2. The composition as claimed in claim 1, wherein the ester reactant consists of 20˜30% by weight of a dehydrated fatty acid (DCOFA), 15˜25% by weight of trimethylolpropane (TMP), 15˜20% by weight of isophthalic acid (IP acid), 3˜7% by weight of trimellitic anhydride (TMA) and 30˜35% by weight of butyl cellosolve.

3. A paint produced using a mixture of 50˜65% by weight of the alkyd resin composition according to claim 1 and 35˜50% by weight of a non-toxic pigment for color expression.
